(19) United States
(12) Patent Application Publication
(10) Pub. No.: US 2008/0150921 A1
(43) Pub. Date: Jun. 26, 2008

(54) Supplementing and controlling the display of a data set

(75) Inventors: George G. Robertson, Seattle, WA (US); Daniel Chaim Robbins, Seattle, WA (US)

Correspondence Address: MICROSOFT CORPORATION, ONE MICROSOFT WAY, REDMOND, WA, 98052-6399, US

(73) Assignee: Microsoft Corporation, Redmond, CA (US)

(21) Appl. No.: 11/642,081

(22) Filed: Dec. 20, 2006

(51) Int. Cl. G06F 3/038

(52) U.S. Cl. 345/204

(57) ABSTRACT

Methods and computer-readable media are provided for supplementing and controlling the display of data set. According to one method, a view of a data set is adaptively rendered on a stationary display device. The location of a portable computing device with respect to the stationary display device is then determined. An area of the stationary display device corresponding to the location of the portable computing device is then determined, and the portion of the data set being rendered in the area is also calculated. Supplemental data corresponding to the portion of the data set rendered in the identified area is then adaptively rendered on a display of the portable computing device. Movement of the portable computing device may also be utilized to control the manner in which the data set is rendered on the stationary display device.

### BACKGROUND

Computer application programs continue to become more and more complex. This is true in general with regard to the increased functionality provided by many application programs and also with regard to the level of skill required to meaningfully utilize these advanced features. Despite the increased functionality provided and the increased level of skill required to utilize this functionality, however, the user input devices supported for controlling such application programs have generally remained limited to a computer mouse, a keyboard, or a combination of the two devices.

As a result of the spatial limitations of mouse and keyboard input devices and the increased functionality provided by many application programs, users today must often make complex key-and-mouse input combinations in order to control the display of a program and to invoke various modes and modifiers. This is especially true of application programs that display and permit the navigation of multi-scale data sets. For instance, mapping application programs exist that allow a user to view a map, to pan the map, and to zoom into and out of the map at various scales, or resolutions. Specifying the position and zoom level of the map while attempting to maintain focus on a particular part of the data set can be difficult using current user input mechanisms.

Programs for displaying and navigating multi-scale data sets also allow many additional types of information to be displayed overlaying or in conjunction with the display of the data set. For instance, a mapping program may allow a user to specify that various details such as street names, points-of-interest, embedded hyperlinks, or other information, be displayed with the map while it is panned and zoomed. However, in order to have this information displayed, a user typically has to either pre-select a series of viewing filters prior to navigation of the map or to select from various complicated on-object options. These types of input mechanisms for controlling the display of a data set can be complicated and confusing for users.

It is with respect to these considerations and others that the disclosure made herein is provided.

### SUMMARY

Methods and computer-readable media are provided herein for supplementing and controlling the display of a data set. Through the embodiments presented herein, a portable computing device equipped with a display, such as a personal digital assistant (“PDA”), tablet personal computer (“PC”), or a wireless telephone, may be utilized to supplement and control the display of a data set on a stationary display device. Through the use of such a portable computing device, a user can easily control how a multi-scale data set is displayed on the stationary display device and can also view supplemental information relating to portions of the data set on the display screen of the portable computing device.

According to one aspect presented herein, methods are provided for supplementing the view of a data set rendered on a stationary display device using a portable computing device with a display. According to one method, a view of a multi-scale data set is adaptively rendered on the stationary display device. Adaptive rendering allows a view of a multi-scale data set to be rendered in a manner that allows the view of the data set to be continuously and fluidly panned and zoomed. Once the data set has been rendered, the location of the portable computing device with respect to the location of the stationary display device is determined. For instance, according to embodiments, the spatial configuration, including the three-dimensional location and orientation, of the portable computing device with relation to the stationary display device is determined.

Once the location of the portable computing device has been determined with respect to the stationary display device, an area on the stationary display device corresponding to the location of the portable computing device is identified. As an example, an area of the stationary display device “behind,” or “underneath,” the portable computing device may be identified. Once this area had been identified, the portion of the data set rendered in the identified area is determined. Supplemental data for the portion of the data set rendered in the identified area may then be adaptively rendered on the display of the portable computing device.

According to implementations, the supplemental data shown on the display screen of the portable computing device may include a more detailed view of the portion of the data set rendered in the identified area. As an example, the display of the portable computing device may show a zoomed view of the portion of the data set in the identified area. The supplemental data may also include an alternate representation of the portion of the data set in the identified area. For instance, if the data set shown on the stationary display is a satellite map, the display on the portable computing device may be utilized to display a road map for the identified area. The supplemental data may further include additional data for the portion of the data set shown in the identified area. For instance, annotations or other data for the portion of the data set shown in the identified area may be adaptively rendered on the display of the portable computing device.

According to other aspects, when movement of the portable computing device is detected, the data rendered on the display of the portable computing device is updated and adaptively rendered based upon the current location of the portable computing device with respect to the stationary display device. In this manner, the portable computing device may be utilized to view supplemental data for any portion of the data set shown on the stationary display device. By moving the portable computing device in all three dimensions, a user may zoom into and out of and pan over the view of the data set shown on the stationary display device. The updated view of the appropriate portion of the data set is adaptively rendered on the portable computing device.

According to other implementations, one or more user interface controls provided by the portable computing device may be utilized to control the view of the data set on the stationary display device and on the portable computing device. For instance, in one implementation graphical user interface controls may be shown on the display of the portable computing device. Through the use of the graphical user interface controls, a user may cause commands to be issued to a computer operating the stationary display device. For instance, the graphical user interface controls on the portable computing device may be utilized to specify data that should be displayed on the stationary display device, to specify data that should be displayed on the display of the portable computing device, or to issue commands to on-screen objects displayed in the portion of the stationary display device behind the portable computing device. Other types of user interface controls may be utilized in a similar manner.

According to another aspect described herein, methods are also provided for controlling the view of a data set rendered on a stationary display device using a portable computing device with a display. According to one method, a view of a multi-scale data set is adaptively rendered on the stationary display device. The location of the portable computing device is then determined with respect to the stationary display device. When movement of the portable computing device is detected, an updated view of the data set shown on the stationary display device is computed and adaptively rendered based upon the movement of the portable computing device.

In an implementation, moving the portable computing device in a plane parallel to the stationary display device causes the view of the data set shown on the stationary display device to be continuously and fluidly panned. Movement of the portable computing device in a plane perpendicular to the stationary display device causes the view of the data set shown on the stationary display device to be fluidly zoomed into or out of. Rotation of the portable computing device on an axis causes the view of the data set shown on the stationary display device to be fluidly rotated in a corresponding direction. A view of the data set may also be shown on the display of the portable computing device along with user interface controls for controlling the view of the data set shown on the stationary display device.

The above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network and software diagram showing an illustrative operating environment for the processes and computer systems described herein and aspects of several of the software components utilized by the computer systems presented herein;

FIG. 2 is a perspective diagram showing aspects of a stationary display device and a portable computing device utilized in the various embodiments presented herein;

FIGS. 3-4 are flow diagrams illustrating various processes provided herein for supplementing and controlling the display of a data set; and

FIG. 5 is a computer architecture diagram showing a computer architecture suitable for implementing the methods provided herein for supplementing and controlling the display of a data set.

### DETAILED DESCRIPTION

The following detailed description is directed to systems, methods, and computer-readable media for supplementing and controlling the display of a data set. As will be discussed in greater detail below, a portable computing device with a display can be utilized to control and supplement the view of a data set shown on a stationary display device. While the subject matter described herein is presented in the general context of program modules that execute in conjunction with the execution of an operating system and application programs on a computer system, those skilled in the art will recognize that other implementations may be performed in combination with other types of program modules.

Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The subject matter described herein is also described as being practiced in a distributed computing environment where tasks are performed by remote processing devices that are linked through a communications network and wherein program modules may be located in both local and remote memory storage devices. It should be appreciated, however, that the implementations described herein may also be utilized in conjunction with stand-alone computer systems and other types of computing devices. It should also be appreciated that although reference is made herein to the Internet, the embodiments presented herein may be utilized with any type of local area network (“LAN”) or wide area network (“WAN”).

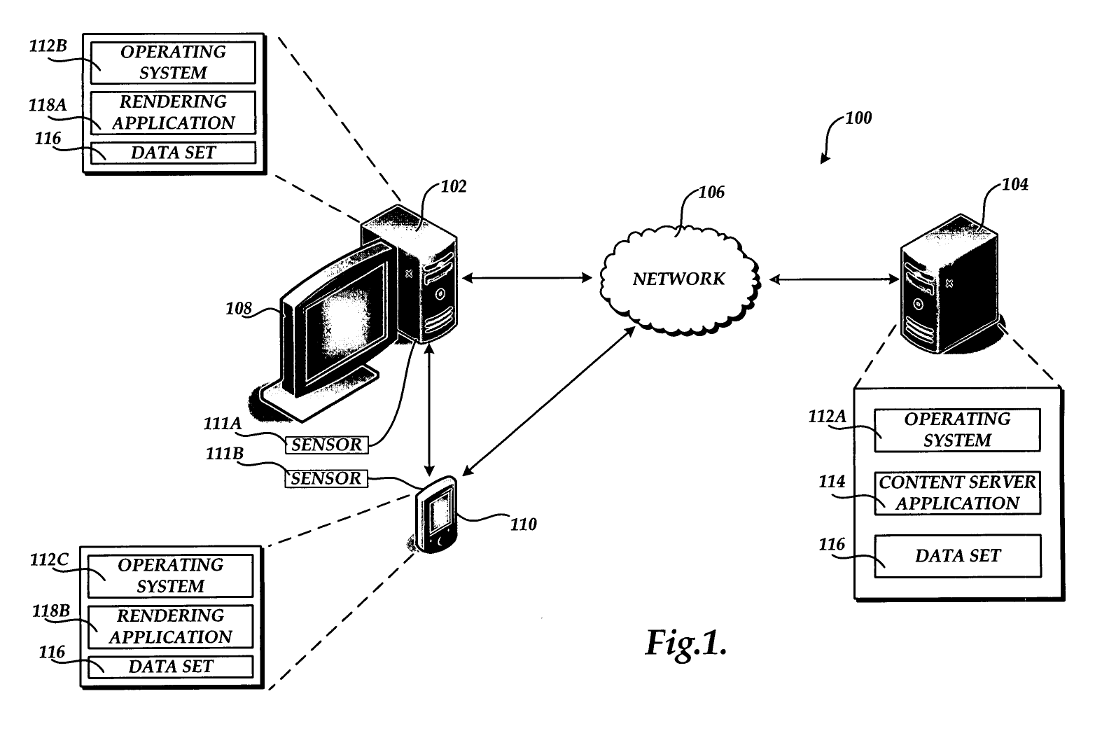

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for controlling and supplementing the display of a data set on a stationary display device will be described. In particular, FIG. 1 is a network diagram illustrating aspects of an illustrative operative environment 100 for the subject matter described herein that includes a computing system 102 having a stationary display device 108 connected thereto, a portable computing device 110, a server computing system 104, and a network 106.

As shown in FIG. 1, the computing system 102, the computing system 104, and the portable computing device 110 are communicatively coupled to one another through respective connections to the network 106. According to one implementation, the network 106 comprises the Internet. However, it should be appreciated that the network 106 may comprise a LAN, WAN, or other type of suitable network for connecting the various computing systems in the manner described herein. As also shown in FIG. 1, the portable computing device 110 may also connect directly to the computing system 102 in various embodiments utilizing a suitable wired or wireless communication medium, such as BLUETOOTH, WI-FI, infrared, or other type of device-to-device connection.

FIG. 1 also illustrates a number of software components utilized by the computing system 102, the computing system 104, and the portable computing device 110. In particular, the computing system 102 includes an operating system 112A suitable for controlling the operation of a networked desktop or laptop computer. The computing system 104 includes an operating system 112B suitable for controlling the operation of a networked server computer. For instance, according to implementations, both the computing system 102 and the computing system 104 may utilize the WINDOWS XP or WINDOWS VISTA operating systems from MICROSOFT CORPORATION of Redmond, Wash. Other operating systems, such as the LINUX operating system or the OSX operating system from APPLE COMPUTER, INC. may be utilized. It should be appreciated that although the embodiments presented herein are described in the context of a desktop or laptop computing system 102 and a remote server computing system 104, many other types of computing devices and systems may be utilized to embody the various aspects presented herein.

According to embodiments, the portable computing device 110 is a small form factor computing device that includes a display, user input controls, and sufficient memory and computing capability to render a data set in the manner described herein. For instance, according to embodiments, the small computing device 110 may comprise a PDA, a tablet PC, a wireless mobile telephone, or other type of device having these capabilities. The portable computing device 110 may utilize an operating system 112C suitable for controlling the operation of a portable computing device, such as the WINDOWS MOBILE family of operating systems from MICROSOFT CORPORATION, the SYMBIAN operating system licensed by SYMBIAN LIMITED, or the PALM operating system from PALM INCORPORATED. Other types of operating systems suitable for controlling the operation of a portable computing device 110 may also be utilized.

As will be described in greater detail herein, the computing system 102 and the portable computing device 110 provide functionality for adaptively rendering a data set 116 in a manner that allows a user to freely and fluidly zoom into and out of the content at a continuous range of resolutions. This continuous, fluid zooming capability contrasts the discrete zooming capabilities of traditional application programs. In existing applications, the transition between different resolutions is not fluid in that the existing view is erased, followed by a rendering of the document at the requested resolution, resulting in a hesitation as the view transitions.

In contrast, the disclosure presented herein utilizes adaptive rendering algorithms that allow for fluid and continuous transitions between resolutions by extrapolating between stored resolutions to arrive at the requested resolution in a fluid, continuous manner. The amount of data transferred is proportional to the resolution of the display screen on which the data set is rendered. This process is described in U.S. Pat. No. 7,075,535, filed Mar. 1, 2004 and entitled “System and Method for Exact Rendering in a Zooming User Interface,” which is hereby expressly incorporated by reference in its entirety.

In one implementation, the data set 116 is stored at the computing system 104 and made available to the computing system 102 and the portable computing device 110 by the content server application 114. In particular, in this embodiment, the rendering application 118A executing on the computing system 102 and the rendering application 11 8B executing on the portable computing device 110 request, receive, and adaptively render portions of the data set 116 received from the computing system 104. In an alternate embodiment, a copy of the data set 116 is cached locally at both the computing system 102 and the portable computing device 110. In this embodiment, the rendering application 118A and the rendering application 118B adaptively render the data set 116 from the locally cached version. Other implementations may utilize a cached portion of the data set 116 along with portions of the data set 116 received from the computing system 104.

The data set 116 comprises any type of data that may be visualized by the computing system 102 and the portable computing device 110. In one implementation the data set 116 is a multi-scale data set. A multi-scale data set is a data set that includes multiple views of each portion of the data set. For instance, one example of a multi-scale data set is a map data set that includes multiple resolutions of each portion of a map. Such a data set is useful, for instance, for zooming into and out of the map to visualize the details contained in the map at a variety of resolutions. As will be described in greater detail below, the computing system 102 may adaptively render a view of the data set 116 on the stationary display device 108. The portable computing device 110 may then be utilized to control the view of the data set 116 rendered on the stationary display device 108 and to supplement the view of the data set 116 with additional data adaptively rendered on the display of the portable computing device 110.

As shown in FIG. 1, the computing system 102 and the portable computing device 110 may be equipped with sensors 111A and 111B, respectively. The sensors 111A and 111B allow the location of the portable computing device 110 to be determined with respect to the stationary display device 108 at any given time. In particular, in implementations, the sensors 111A and 111B allow the spatial configuration of the portable computing device 110 with respect to the stationary display device 108 to be determined. This includes, for instance, the relative location of the portable computing device 110 with respect to the stationary display device 108 and the spatial orientation of the portable computing device 110.

According to embodiments, the computing system 102 alone is equipped with a sensor 111A for determining the relative location of the portable computing device 110. In an alternate embodiment, the portable computing device 110 alone is equipped with a sensor 111B for determining the relative location of itself. In another embodiment, both the computing system 102 and the portable computing device 110 are equipped with sensors 111A and 111B, respectively, that operate in conjunction to determine the relative location of the portable computing device 110.

According to implementations, the sensors 111A and 111B comprise an accelerometer, an infrared receiver/transmitter, short-range radio transceivers, ultrasonic sensors, or another types of sensor capable of determining the location of the portable computing device 110 with respect to the stationary display device 108. In another implementation, the sensor 111B comprises a camera that may be utilized by the portable computing device 110 to determine its location relative to the stationary display device 108. The sensors 110A and 110B may be internal or external to the stationary display device 108 and the portable computing device 110, respectively.

It should be appreciated that the stationary display device 108 may comprise any type of display device, such as a cathode ray tube (“CRT”) display, a liquid crystal display (“LCD”), a plasma display, a projector, or other type of display. The stationary display device 108 is referred to herein as being stationary to indicate that the device is not moved during its operation as described herein. The term stationary as utilized is not meant to indicate that the device cannot be moved. The display within the portable computing device 110 may also comprise a display device suitable for use in a small form factor computing system, such as an LCD display.

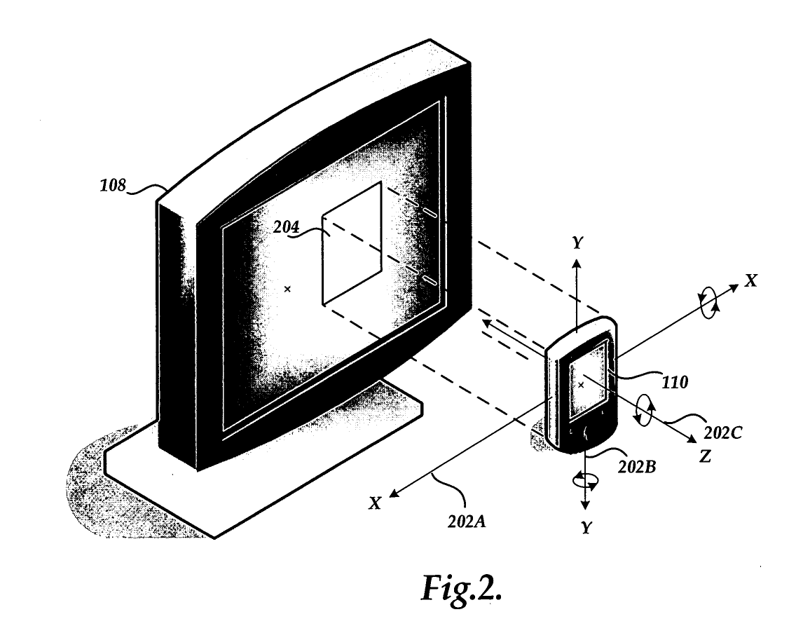

Turning now to FIG. 2, additional details will be described regarding the aspects presented herein for determining the location of the portable computing device 110 with respect to the stationary display device 108. In particular, FIG. 2 is a perspective diagram illustrating aspects of the stationary display device 108 and the portable computing device 110. As shown in FIG. 2, the portable computing device 110 may be moved in three dimensions relative to the stationary display device 108. In particular, the portable computing device 110 may be moved in a plane parallel to the stationary display device 108 along the X-axis 202A and the Y-axis 202B, or in a plane perpendicular to the stationary display device 108 along the Z-axis 202C. The sensors 110A and 110B are utilized to determine the movement of the portable computing device 110 in this manner.

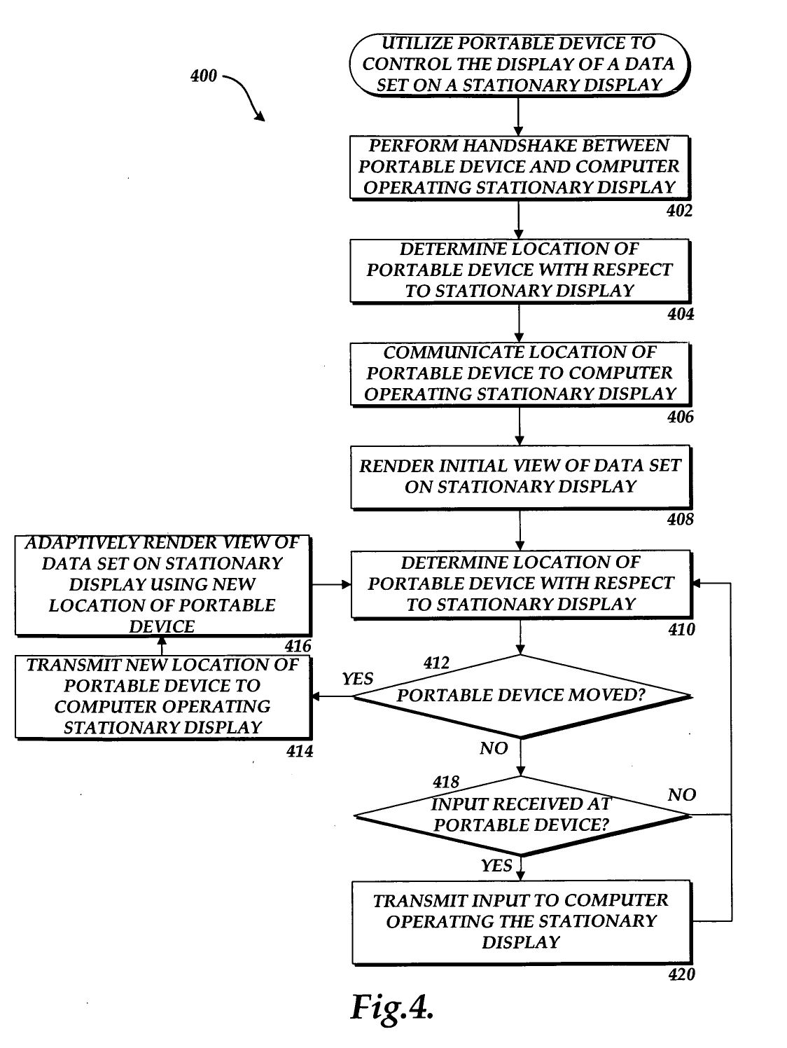

According to implementations, the portable computing device 110 can also be rotated along the X-axis 202A, the Y-axis 202B, or the Z-axis 202C. The sensor 111B in the portable computing device 110 can be utilized to determine the rotational orientation of the device. As will be described in greater detail below, by continually monitoring the location of the portable computing device 110 and communicating this information to the computing system 102, the portable computing device 110 can be utilized to control the display of the data set on the stationary display device 108. The portable computing device 110 can also be utilized to control the display in additional ways, described below. Additional details regarding the implementations provided herein for controlling the display of the data set 116 with the portable computing device 110 are described below with reference to FIG. 4.

As shown in FIG. 2, the spatial configuration of the portable computing device 110 can be utilized to determine an area 204 on the stationary display device 108 that corresponds to the location of the portable computing device 110. In one implementation, the area 204 corresponds to the area of the stationary display device 108 that is “behind,” or “underneath,” the portable computing device 110. The area 204 may comprise another area of the stationary display device 108 in other implementations.

As will be described in greater detail below, once the area 204 of the stationary display device 108 corresponding to the location of the portable computing device 110 has been identified, the portion of the data set 116 that is being displayed within the area 204 can also be identified. Once this has been accomplished, the display on the portable computing device 110 can display supplemental information regarding the portion of the data set 116 displayed in the area 204. For instance, a more detailed view, an alternate view, or additional data for the portion of the data set 116 shown in the area 204 may be adaptively rendered on the display of the portable computing device 110. Additional details regarding the implementations provided herein for supplementing the display of the data set 116 using the display of the portable computing device 110 are described below with reference to FIG. 4.

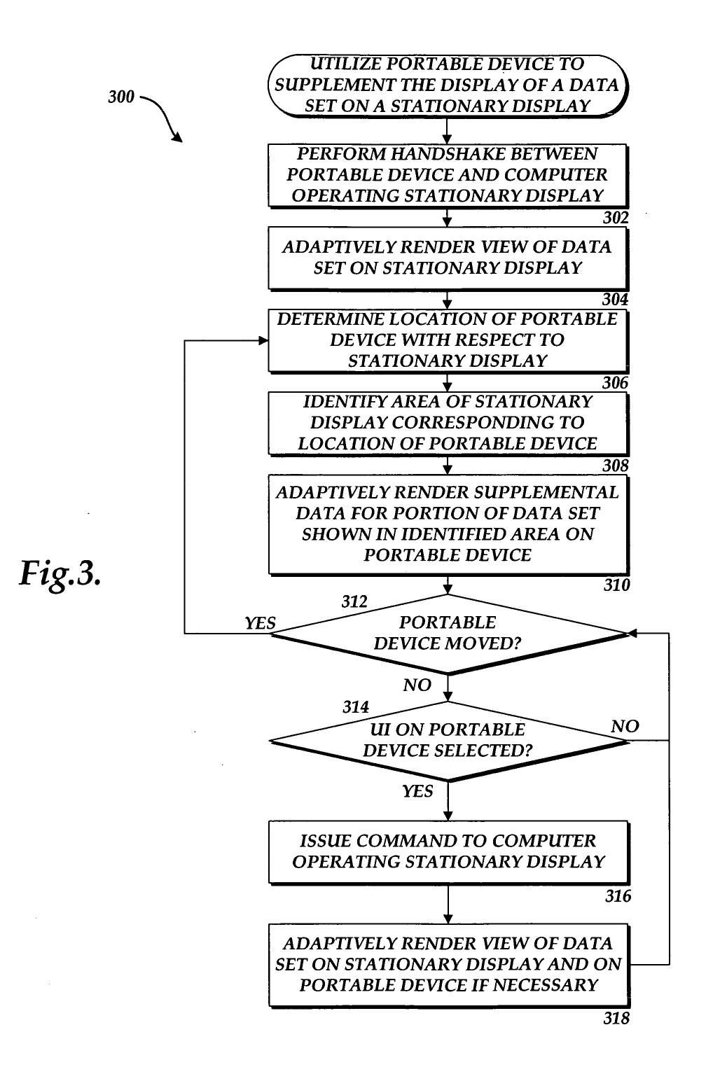

Referring now to FIG. 3, additional details will be provided regarding the embodiments presented herein for supplementing the display of a data set. In particular, FIG. 3 is a flow diagram showing a routine 300 that illustrates the operation of the computing system 102 and the portable computing device 110 for supplementing the display of the data set 116 on the stationary display device 108. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination.

The routine 300 begins at operation 302, where a handshake operation is performed between the computing system 102 and the portable computing device 110. Through the handshake operation, the computing system 102 and the portable computing device 110 specify the particular data set 116 to be utilized. These two devices may also exchange information regarding their particular graphics capabilities in order to best operate in concert. For instance, each device may transmit information describing the resolution, color depth, and other current viewing parameters for its display. The portable computing device 110 may also communicate its input capabilities to the computing system 102. It should be appreciated that the network 106 or a direct communications link between the two devices may be utilized to perform the handshake operation.

It should also be appreciated that, according to embodiments, once the handshake operation has been performed, there is no need for additional communication between the computing system 102 and the portable computing device 110. For instance, where the display of the portable computing device 110 is utilized to supplement a view of the data set 116 shown on the stationary display device 108, there is no need to exchange any additional information after the handshake operation. If the view of the data set 116 shown on the stationary display device 108 is modified, it may be necessary to communicate this information to the portable computing device 110 so that it may update its view of the data set 116. In the embodiment wherein the portable computing device 110 is utilized to control the view of the data set 116 shown on the stationary display device 108, information regarding the location of the portable computing device 110 and any user input made on the device is continually transmitted to the computing system 102 via the network 106 or a suitable device-to-device connection.

Once the handshake operation has been performed, the routine 300 continues from operation 302 to operation 304. At operation 304, the computing system 102 adaptively renders a view of the data set 116 on the stationary display device 108. For instance, where the data set 116 is a multi-scale data set of a map, the computing system 102 may adaptively render a portion of the map at one resolution on the stationary display device 108. Once the view of the data set 116 has been adaptively rendered on the stationary display device 108, the routine 300 continues to operation 306, where the location of the portable computing device 110 with respect to the stationary display device 108 is determined in the manner described above with reference to FIGS. 1 and 2. From operation 306, the routine 300 continues to operation 308.

At operation 308, the area 204 of the stationary display device 108 corresponding to the determined location of the portable computing device 110 is identified. The portion of the data set 116 being rendered by the computing system 102 within the identified area 204 is also determined. Once the portion of the data set 116 being rendered in the area 204 has been determined, the routine 300 continues to operation 310.

At operation 310, the portable computing device 110 renders supplemental data for the portion of the data set 116 in the area 204 on its display. For instance, in one embodiment the supplemental data comprises a more detailed view of the portion of the data set 116 than what is rendered on the stationary display device 108. For instance, by moving the portable computing device 110 toward the stationary display device 108, a more detailed view of the portion of the data set 116 rendered in the area 204 may be shown on the display of the portable computing device 110.

In other embodiments, the supplemental data rendered on the display of the portable computing device 110 comprises an alternate representation of the portion of the data set 116 rendered in the area 204. For instance, if the data set 116 shown on the stationary display device 108 is a satellite map, the display on the portable computing device 110 may be utilized to display a road map for the identified area 204. According to aspects, the supplemental data may further include additional data for the portion of the data set 116 shown in the identified area 204. For instance, annotations or other data for the portion of the data set 116 shown in the identified area 204 may be adaptively rendered on the display of the portable computing device 110. It should be appreciated that, in general, the supplemental data comprises any type of data that elucidates the portion of the data set 116 shown in the area 204.

Once the supplemental data has been displayed on the portable computing device 110, the routine 300 continues from operation 310 to operation 312. At operation 312, a determination is made as to whether the portable computing device 110 has been moved. If the portable computing device 110 has been moved, the routine 300 branches to operation 312, described above, where the display of the portable computing device 110 is adaptively rendered to display supplemental data for a new area corresponding to the new location of the portable computing device 110. In this manner, the portable computing device 110 always displays supplemental data for the portion of the data set 116 that is being displayed under the portable computing device. As a user moves the portable computing device 110 parallel to the stationary display device 108 or toward or back from the stationary display device 108, the display on the portable computing device 110 is updated accordingly.

If movement is not detected at operation 312, the routine 300 continues from operation 312 to operation 314. At operation 314, a determination is made as to whether a user input control has been selected on the portable computing device 110 for controlling the display of the data set 116 on the stationary display device 108. For instance, in one embodiment, resolution appropriate graphical user interface controls are displayed on the display of the portable computing device 110 through which aspects of the view of the data set 116 on the stationary display device 108 may be modified. The graphical user interface may be actuated using hardware buttons, a touch screen and stylus, or other suitable mechanism. Alternatively, user input may be made simply through the actuation of hardware buttons on the portable computing device 110.

If the portable computing device 110 determines that user input has not been made at operation 314, the routine 300 branches back to operation 312, described above. If, however, user input has been made, the routine 300 continues from operation 314 to operation 316, where a command is issued from the portable computing device 110 to the computing system 102 to modify the display of the data set 116. For instance, the user interface on the portable computing device 110 may be utilized to select overlays shown over the data set 116, to change the data set 116, or to issue a command to an on-screen object located within the area 204. The user interface shown on the portable computing device 110 may also be utilized in this manner to modify what is shown on its own display. For instance, the user interface may be utilized to select overlays for the view of the data set 116 that is adaptively rendered on the portable computing device 110.

From operation 316, the routine 300 continues to operation 318. At operation 318, the view of the data set 116 shown on the stationary display device 108 is updated based upon the user interface selection. The display on the portable computing device 110 may also be updated if the user selection modified the view of the data set 116 shown on the portable computing device 110. From operation 318, the routine 300 returns to operation 312, described above for additional processing in a similar manner.

Turning now to FIG. 4, additional details will be provided regarding the embodiments presented herein for controlling the display of a data set. In particular, FIG. 4 is a flow diagram showing a routine 400 that illustrates the operation of the computing system 102 and the portable computing device 110 for controlling the display of the data set 116 on the stationary display device 108 with the portable computing device 110. In this implementation, movement of the portable computing device 110 is detected and utilized to control how the data set 116 is shown on the stationary display device 108. For instance, movement of the portable computing device 110 in a plane parallel to the stationary display device 108 may cause the view of the data set 116 to be panned on the stationary display device 108, movement in a plane perpendicular to the stationary display device 108 may cause the view of the data set 116 to be zoomed on the stationary display device 108, and rotation of the portable computing device 110 may cause the view of the data set 116 to be rotated on the stationary display device 108.

The routine 400 begins at operation 402, where a handshake operation is performed between the computing system 102 and the portable computing device 110 in the manner described above with reference to FIG. 3. Once the handshake operation has been performed, the routine 400 continues from operation 402 to operation 404. At operation 404, the location of the portable computing device 110 with respect to the stationary display device 108 is determined in the manner described above. The routine 400 then continues to operation 406, where the location of the portable computing device 110 is communicated to the computing system 102. The current location of the portable computing device 110 is utilized by the computing system 102 to render a view of the data set 116 at operation 408.

From operation 408, the routine 400 continues to operation 410, where the location of the portable computing device 110 is again determined with respect to the stationary display device 108. The routine 400 then continues to operation 412, where a determination is made as to whether the portable computing device 110 has been moved. If so, the routine 400 branches from operation 414, where the new location and orientation of the portable computing device 110 is transmitted to the computing system 102.

From operation 414, the routine 400 continues to operation 416, where the new location or orientation of the portable computing device 110 is utilized to adaptively render an updated view of the data set 116 on the stationary display device 108. For instance, if the portable computing device 110 is moved in a plane parallel to the stationary display device 108, the view of the data set 116 is panned on the stationary display device 108. If the portable computing device 110 is moved in a plane perpendicular to the stationary display device 108, the view of the data set 116 is zoomed in or out on the stationary display device 108. If the portable computing device 110 is rotated on an axis, the view of the data set 116 is rotated on the stationary display device 108 by the computing system 102. The routine 400 then returns to operation 410 for additional processing in the manner described above.

If, at operation 412, no movement of the portable computing device 110 is detected, the routine 400 continues from operation 412 to operation 418. At operation 418, a determination is made as to whether user input has been made at the portable computing device 110 such as through a graphical user interface or a hardware button. If no user input has been received, the routine 400 branches back to operation 410, described above. If user input has been received, however, the routine 400 continues from operation 418 to operation 420, where an appropriate command is transmitted from the portable computing device 110 to the computing system 102 based on the user input. The command may be utilized, for instance, to change the data set shown on the stationary display device 108, to modify information shown in conjunction with the display of the data set 116, or to otherwise interact with the view of the data set 116 shown on the stationary display device 108. From operation 420, the routine 400 returns to operation 410, described above.

According to another implementation, the modes of operation described above with respect to FIGS. 3 and 4 may be utilized conjunctively. In this mode of operation, a user interface control on the portable computing device 110 operates as a clutch control for switching between the mode of operation described above with respect to FIG. 3 and the mode of operation described above with respect to FIG. 4. If the user interface control is engaged, the portable computing device 110 operates to control the display as described above with respect to FIG. 4. If the user interface control is disengaged, the portable computing device 110 operates to control the display in the manner described above with respect to FIG. 3.

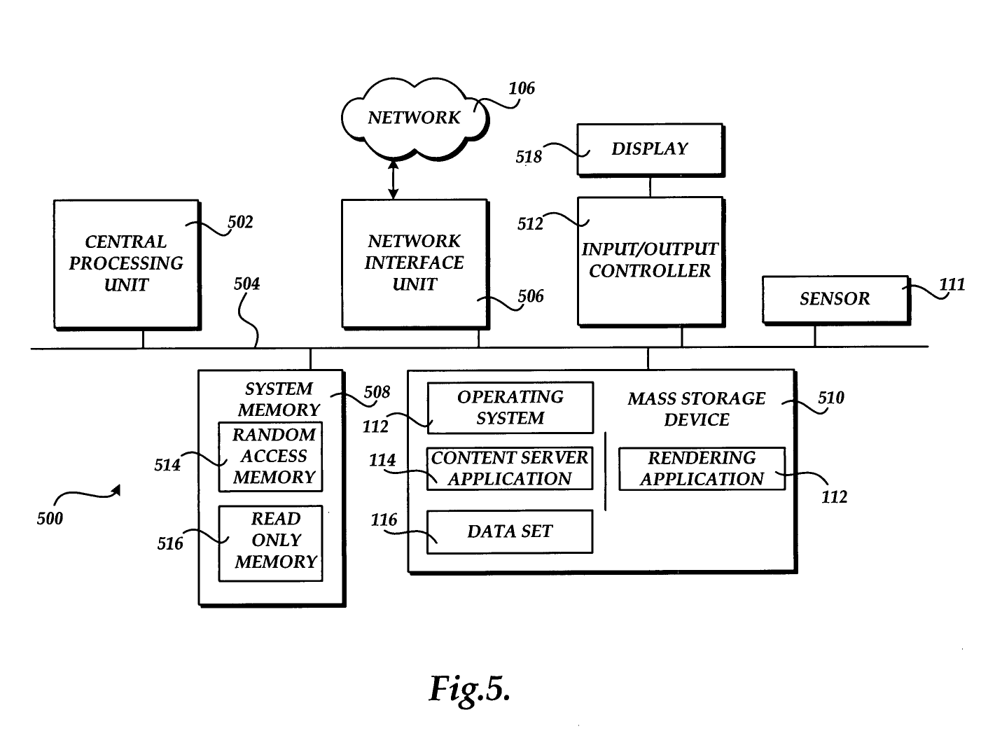

Referring now to FIG. 5, an illustrative computer architecture for a computer 500 utilized in the various embodiments presented herein will be discussed. The computer architecture shown in FIG. 5 illustrates a computing architecture for a conventional desktop, laptop, server, or portable computing system. The computing architecture illustrated in FIG. 5 may be utilized to embody the computing systems 102 and 104 or the portable computing device 110.

The computer architecture shown in FIG. 5 includes a central processing unit 502 (“CPU”), a system memory 508, including a random access memory 514 (“RAM”) and a read-only memory (“ROM”) 516, and a system bus 504 that couples the memory to the CPU 502. A basic input/output system containing the basic routines that help to transfer information between elements within the computer 500, such as during startup, is stored in the ROM 516. The computer 500 further includes a mass storage device 510 for storing an operating system 112, application programs, and other program modules, which have been described in greater detail herein.

The mass storage device 510 is connected to the CPU 502 through a mass storage controller (not shown) connected to the bus 504. The mass storage device 510 and its associated computer-readable media provide non-volatile storage for the computer 500. Although the description of computer-readable media contained herein refers to a mass storage device, such as a hard disk or CD-ROM drive, it should be appreciated by those skilled in the art that computer-readable media can be any available media that can be accessed by the computer 500.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 500.

According to various embodiments, the computer 500 may operate in a networked environment using logical connections to remote computers through a network 106, such as the Internet. The computer 500 may connect to the network 106 through a network interface unit 506 connected to the bus 504. It should be appreciated that the network interface unit 506 may also be utilized to connect to other types of networks and remote computer systems. The computer 500 may also include an input/output controller 512 for receiving and processing input from a number of other devices, including a keyboard, mouse, or electronic stylus (not shown in FIG. 5). Similarly, an input/output controller may provide output to a display 518. As discussed above, the display 518 may be internal, such as the display within the portable computing device 110, or external like the stationary display device 108. The display 518 may also utilize any appropriate display technology.

As mentioned briefly above, a number of program modules and data files may be stored in the mass storage device 510 and RAM 514 of the computer 500, including an operating system 112 suitable for controlling the operation of a networked desktop, server, or portable computing system, such as the WINDOWS XP operating system from MICROSOFT CORPORATION of Redmond, Wash., or the WINDOWS VISTA operating system, also from MICROSOFT CORPORATION. The mass storage device 510 and RAM 514 may also store one or more program modules. In particular, the mass storage device 510 and the RAM 514 may store the content server application 114 or the rendering application program 118, as appropriate. The mass storage device 510 may also store a copy of the data set 116. Other program modules may also be stored in the mass storage device 510 and utilized by the computer 500.

Based on the foregoing, it should be appreciated that systems, methods, and computer-readable media for supplementing and controlling a view of a data set are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for supplementing a view of a data set rendered on a stationary display device using a portable computing device with a display, the method comprising:
adaptively rendering the data set on the stationary display device;
determining a location of the portable computing device with respect to the stationary display device;
identifying an area of the stationary display device corresponding to the location of the portable computing device;
identifying a portion of the data set rendered in the area; and
adaptively rendering supplemental data for the portion of the data set on the display of the portable computing device.

2. The method of claim 1, wherein the supplemental data comprises a more detailed view of the portion of the data set than rendered on the stationary display device.

3. The method of claim 1, wherein the supplemental data comprises an alternate representation of the portion of the data set rendered on the stationary display device.

4. The method of claim 1, wherein the supplemental data comprises additional data for the portion of the data set not rendered on the stationary display device.

5. The method of claim 1, further comprising:
detecting a movement of the portable computing device;
in response to detecting the movement of the portable computing device, determining a new location of the portable computing device with respect to the stationary display device;
identifying a new area of the stationary display device corresponding to the new location of the portable computing device;
identifying a new portion of the data set rendered in the new area; and
adaptively rendering the supplemental data for the new portion of the data set on the display of the portable computing device.

6. The method of claim 1, further comprising:
displaying a user interface control on the display of the portable computing device;
receiving an actuation of the user interface control; and
in response to the actuation of the user interface control, issuing a command to an item rendered in the area.

7. The method of claim 1, wherein determining the location of the portable computing device comprises determining a spatial configuration of the portable computing device.

8. A method for controlling a view of a data set rendered on a stationary display device using a portable computing device with a display, the method comprising:
adaptively rendering a first view of the data set on the stationary display device;
determining a location of the portable computing device with respect to the stationary display device;
detecting a movement of the portable computing device; and
in response to detecting the movement of the portable computing device, determining a new location of the portable computing device with respect to the stationary display device and adaptively rendering a second view of the data set on the stationary display, the second view comprising a view of the data set determined based upon the new location of the portable computing device.

9. The method of claim 8, further comprising:
adaptively rendering a view of the data set on the portable computing device; and
updating the view of the data set rendered on the portable computing device in response to detecting the movement of the portable computing device.

10. The method of claim 8, wherein detecting a movement of the portable computing device comprises detecting a movement of the portable computing device within a plane parallel to the stationary display device, and wherein adaptively rendering a second view of the data set on the stationary display comprises adaptively panning the first view of the data set based upon the movement of the portable computing device.

11. The method of claim 8, wherein detecting a movement of the portable computing device comprises detecting a movement of the portable computing device within a plane perpendicular to the stationary display device, and wherein adaptively rendering a second view of the data set on the stationary display comprises adaptively zooming the first view of the data set based upon the movement of the portable computing device.

12. The method of claim 8, wherein detecting a movement of the portable computing device comprises detecting a rotation of the portable computing device, and wherein adaptively rendering a second view of the data set on the stationary display comprises adaptively rotating the first view of the data set based upon the movement of the portable computing device.

13. The method of claim 8, further comprising:
displaying a user interface control on the display of the portable computing device;
receiving an actuation of the user interface control; and
in response to the actuation of the user interface control, issuing a command to from the portable computing device to a computer operating the stationary display device.

14. A computer-readable medium having computer-executable instructions stored thereon which, when executed by a computer, cause the computer to:
adaptively render a view of a data set on a display screen;
determine a spatial position of a portable computing device with respect to a location of the display screen;
identify a portion of the display screen corresponding to the spatial position of the portable computing device;
determine a subset of the data set rendered on the portion of the display screen corresponding to the spatial position of the portable computing device; and to
cause supplemental data for the subset to be adaptively rendered on a display of the portable computing device.

15. The computer-readable medium of claim 14 having further computer-executable instructions stored thereon which, when executed by the computer, cause the computer to:
detect a movement of the portable computing device;
in response to detecting the movement, to determine a new spatial position of the portable computing device with respect to the location of the display screen;
identify a new portion of the display screen corresponding to the new spatial position of the portable computing device;
identify a new subset of the data set rendered on the new portion of the display screen; and to
cause supplemental data for the new subset to be adaptively rendered on the display of the portable computing device.

16. The computer-readable medium of claim 15 having further computer-executable instructions stored thereon which, when executed by the computer, cause the computer to adaptively render a new view of the data set on the display screen in response to detecting the movement, the new view determined based upon the new spatial position of the portable computing device.

17. The computer-readable medium of claim 16, wherein adaptively rendering the new view comprises adaptively panning the view of the data set based upon the movement of the portable computing device.

18. The computer-readable medium of claim 17, wherein the supplemental data comprises a more detailed view of the portion of the data set rendered on the display screen.

19. The computer-readable medium of claim 17, wherein the supplemental data comprises an alternate representation of the portion of the data set rendered on the display screen.

20. The computer-readable medium of claim 17, wherein the supplemental data comprises data corresponding to the portion of the data set not shown on the display screen.
